(19) United States
(12) Patent Application Publication
(10) Pub. No.: US 2011/0154355 A1
(43) Pub. Date: Jun. 23, 2011

(54) METHOD AND SYSTEM FOR RESOURCE ALLOCATION FOR THE ELECTRONIC PREPROCESSING OF DIGITAL MEDICAL IMAGE DATA

(75) Inventors: Detlef Becker, Mohrendorf (DE); Karlheinz Dorn, Kalchreuth (DE); Artur Pusztai, Erlangen (DE)

(73) Assignee: SIEMENS AKTIENGESELLSCHAFT, Munich (DE)

(21) Appl. No.: 12/972,636

(22) Filed: Dec. 20, 2010

(30) Foreign Application Priority Data
Dec. 22, 2009 (DE) 10 2009 060 090.6
Jan. 21, 2010 (DE) 10 2010 005 280.9

(51) Int. Cl. G06F 9/50

(52) U.S. Cl. 718/104

(57) ABSTRACT

A method and a system, for resource allocation provided for implementation of the method, are specified for the electronic preprocessing of digital medical image data. In at least one embodiment, provision is subsequently made to classify a plurality of preprocessing jobs, in particular by way of a classifier module, to determine whether they were generated interactively by a user request or automatically. Each preprocessing job is placed in a queue in accordance with the classification, in particular by way of an execution coordination module of the system. Data processing resources for job execution are assigned to each preprocessing job taking account of the classification, in particular by way of a resource allocation module of the system, with interactive preprocessing jobs being handled with higher priority than automatic preprocessing orders.

### PRIORITY STATEMENT

The present application hereby claims priority under 35 U.S.C. §119 on German patent application numbers DE 10 2009 060 090.6 filed Dec. 22, 2009 and DE 10 2010 005 280.9 filed Jan. 21, 2010, the entire contents of each of which are hereby incorporated herein by reference.

### FIELD

At least one embodiment of the invention generally relates to a method for resource allocation for the electronic preprocessing of digital medical image data. At least one embodiment of the invention further relates to a system which is configured to automatically implement the method.

### BACKGROUND

Medical image data, such as is recorded by medical imaging modalities like for instance a computed tomograph, a magnetic resonance tomograph etc. is usually evaluated at an image processing location, a so-called diagnostic center, after the image recording by a user. The image data is herewith generally processed prior to and/or during the diagnosis using digital image processing methods, in order to assist with the provision of a medical diagnosis on the basis of image data. The better the medical image data was prepared for an efficient image observation, the more efficiently the medical user is generally able to provide the diagnosis.

Examples of preprocessing processes, which render the subsequent diagnosis more efficient, are in particular
the generation of a volume data set (3D image data set) from a plurality of two-dimensional individual images. The volume data set accelerates the loading of the images by the user, who without the volume data set has to consecutively load numerous individual images. The volume data set also significantly aids the visual orientation of the user in the image data.
the removal of distracting information, e.g. bones, from the image data, in order, if necessary, to be able to better see soft parts or vessels for instance.
the use of an image analysis algorithm, by means of which noticeable problems are automatically identified in the medical images. The medical user is then optionally able to show this additional information in the subsequent diagnosis.
the processing of image data sets, which were created using different measuring parameters or also different recording techniques, to form a new combined image data set with improved diagnostic information.

The type of preprocessing which is needed or desirable for a medical diagnosis varies depending on the case. A targeted preprocessing can then frequently only take place if the clinical problem underlying the diagnosis is known and the diagnosis process is clearly defined, i.e. if it is defined which analyses are to be prepared. The need for specific processing steps also frequently only emerges from intermediate results, which are obtained during the diagnosis. Such image processing processes are generally interactively triggered by a user during the diagnosis.

In addition, a plurality of preprocessing processes also exist, which are generally expedient and which can therefore also be implemented in a process carried out before the diagnosis. Such image processing processes are generally automatically started by an image processing facility. However, such a, by default, automatically implemented preprocessing process can in individual cases also be started interactively by a user, if the user requires the result of this preprocessing process promptly, i.e. before the process is implemented automatically.

Preprocessing processes which are started interactively by a user are subsequently abbreviated to “interactive processes”. Preprocessing processes which are started automatically by the system are in contrast subsequently also referred to as “automatic processes” or “system processes”.

So that the medical user can gain the greatest possible benefit from the preprocessing, preprocessing processes which the user starts interactively are desirably to be processed rapidly. On the other hand, waiting times arise for the user, until the missing calculations are implemented, and the images resulting therefrom can be observed.

However, the described preprocessing steps require data processing resources of the system, in particular storage requirement in the main memory, capacity for the reading and writing of the data from and/or onto the hard disk and from time to time significant computing times (i.e. CPU output). In particular, as a result of automatic processes, the interactive work of the medical user can herewith be hindered by excessive resource occupancy.

Uniform resource utilization is desirable to permit a predetermined number of users working in parallel on data processing facilities, said data processing facilities having, for cost reasons, the smallest possible dimensions, to work with as little restriction as possible.

### SUMMARY

In at least one embodiment, an effective method is disclosed for resource allocation for the electronic preprocessing of digital medical image data. In at least one embodiment, a system is further specified, which is particularly suited to implementing the method.

Provision is subsequently made to initially classify a plurality of preprocessing jobs in each instance in order to determine whether they were generated interactively by a user request or whether they were generated automatically. In accordance with this classification (assigned to each preprocessing job), each preprocessing job is then placed in a queue. Data processing resources for job execution are then assigned again to each waiting preprocessing job by taking the respective classification into account. During the allocation of the data processing resources, interactive preprocessing jobs (i.e. such preprocessing jobs which are classified as interactive) are taken into consideration here with higher priority than automatic (i.e. than those classified as automatically generated) preprocessing jobs.

Any electronic allocation is generally understood as “preprocessing job” (abbreviated below to “job”), by which the performance of a specific preprocessing process on a specific image data set is prompted. The content of such a job is for instance to generate a 3D image data set from a specific CT raw data set by way of a specific reconstruction algorithm.

The “classification” of each job preferably takes place to the effect that an electronic item of additional information (classification label) is assigned to the job as an attribute, from which it can be identified whether the job was generated interactively or automatically. The classification label can optionally be integrated or generated as a separate data object using a data link.

An electronic buffer is generally referred to as a “queue”, in which the classified jobs are buffered during the period of time between the setting time and the allocation of the corresponding data processing resources. The queue is herewith generally implemented as a logical First-In-First-Out memory.

In an example embodiment of the method, several queues of the afore-cited type are provided, which are assigned in a class-specific fashion. Each job is therefore always placed in the queue which is assigned to this job in accordance with its classification. In a simple embodiment of the method, a queue is therefore provided for the selective inclusion of interactive jobs, and a further queue is provided for the selective inclusion of automatic jobs.

In an alternative embodiment of the method, it is however also conceivable to provide one or several queues, which are defined in a class-independent fashion and thus include jobs with different classifications. In this case, the classification of the jobs is taken into account during the allocation of the position sequence of the jobs within the or each queue. Interactive jobs, which are preferably to be processed on the basis of their classification, are herewith preferred compared to automatic jobs, which are to be processed as lower priority on the basis of their classification.

The “data processing resources” assigned to each job (subsequently abbreviated to “resources”) generally include all hardware-related requirements which are needed to implement the job. The resources are determined here in particular by a sufficiently large main memory area, adequate computing time or CPU output, and adequate read and write capacity for the reading out and writing of the data connected to the job execution from and/or onto the hard disk.

By classifying the jobs into interactive jobs on the one hand and automatic jobs on the other hand, it is preferably possible, in a particularly simple and effective fashion, to process the interactively generated jobs. The users working with the method, the work progress of which is closely associated with the processing time of the interactively generated jobs, are herewith effectively assisted, while the resource utilization is temporally balanced by the lower priority consideration of automatically generated jobs. The prioritization of the resource allocation namely enables automatically generated jobs to preferably be processed in time frames, in which the available resources are used to capacity to a comparatively small degree by interactive preprocessing jobs and the still more highly prioritized interactive image post-processing.

In addition to a pure classification according to interactive generation and automatic generation, the jobs are preferably also (sub)classified in accordance with the resource requirement to be expected. Both the interactive jobs and also the automatic jobs are herewith assigned in each instance to one of at least two, preferably one of at least three, load classes (e.g. “small”, “medium”, “large”).

The subclassification of the jobs into individual load classes provides for a significantly improved control in respect of the distribution of the available resources into the different job types. In particular, it is herewith prevented that the resources are blocked by jobs of a specific type (in particular jobs with a large resource requirement), while other types of jobs (in particular jobs with a small resource requirement) “starve”, i.e. are excessively delayed.

Logical resource of a predetermined size and/or configuration in each instance are preferably assigned to each load class. Corresponding logical resources are therefore allocated to each job of a specific load class. The load classes are therefore also referred to as “resource types”. In an expedient embodiment, the logical resources reflect the average resource requirement of jobs of this load class, in particular the average main memory requirement and/or the average computing time and/or CPU output and/or the necessary read/write capacity.

The allocation of logical resources to each load class herewith significantly simplifies the resource allocation and also allows for an effective and precise preplanning of the resource utilization in the time average. The software implementing the resource allocation can, with the aid of the logical resources, namely allocate the real resources available to the data processing facility implementing the method and thus control the resource utilization without this software having to know the purpose for which each job requires these resources.

In a preferred embodiment of the method, interactive jobs are unconditionally preferred in comparison with automatic jobs. In this method variant, resources are then only allocated to the automatic jobs placed in the corresponding queue(s) if there are no interactive jobs in the assigned queue and/or one of the assigned queues.

Alternatively, provision can however also be made for this purpose for the available resources to be divided into automatic and interactive jobs in accordance with a predetermined quota regulation. A portion of the resources exceeding 50% and below 100% is herewith allocated to the interactive jobs. This quota can be fixedly predetermined. Provision can however also be made for the quota, e.g. in accordance with the number of jobs placed in the individual queues, to be varied in order to prevent a “job jam” in individual queues. If the jobs are subclassified into load classes, sub-quotas can optionally also be fixedly or variably predetermined for each load class in order to ensure a largely equal processing of varying sizes of jobs. Such a sub-quota is then also referred to as a “distribution key”.

In a further embodiment of the method, no quota of the available resources is predetermined for individual load classes for the same purposes as the “distribution key”. Instead, for different load classes in each instance, the distribution key contains a specification relating to the maximum number of jobs of this load class to be executed consecutively. For instance, a maximum number of 7 for small jobs, a maximum number of 3 for medium jobs and a maximum number of 1 for large jobs is defined as the distribution key. This results in resources having to be allocated to a job of another load class after each large job and/or each third medium job processed in a row and/or each seventh small job processed in a row.

The afore-described distribution key can be permanently and uniformly predetermined without further conditions. It is however preferably predetermined independently for interactive jobs and automatic jobs, in particular with different resource requirements corresponding to determined maximum number of jobs. In addition or alternatively, the distribution key is preferably defined variably in accordance with the jobs placed in the queue and/or the queues. For instance, a higher maximum number is allocated to small jobs, if small jobs exist in the corresponding queue, while the queue assigned to the large jobs is empty.

In addition to the prioritization of the existing jobs in accordance with the queue position and if applicable the distribution key, a further prioritization of the jobs at operating system level optionally takes place. A corresponding priority is thus assigned to each job in accordance with its classification also at operating system level. For instance, the same priority is assigned to interactive preprocessing processes on the operating system level as to interactively started image postprocessing processes, so that the current diagnostic action is not blocked by delayed processing of the necessary preprocessing steps. In contrast, a lower priority is also assigned to automatic preprocessing processes at operating system level too, so that these processes are processed by the system correspondingly more slowly.

In the event that similar jobs can be generated both automatically and also interactively by user requests, it may ensue that jobs with the same content are generated approximately at the same time both automatically and also actively by a user. If several users work with the method at the same time, it may also ensue that jobs with the same content are independently generated by several users within a close time interval. For instance, the job for generating a 3D image data set using a specific reconstruction algorithm from a specific CT raw data set is created automatically on the one hand and interactively by a user on the other hand.

In order to prevent redundant job processing in this case and thus to conserve resources as far as possible, in a preferred method variant a label identifier is generated for each preprocessing job, which identifies at least the type of preprocessing and the data to be preprocessed. The label identifier is generated in particular in the form of a hash code from the job data, which is assigned to the job as an additional attribute. By comparing this label identifier, the jobs placed in the queue and/or queues are examined for redundancy. If two or more jobs are found with matching, in particular identical label identifiers, only one of the associated jobs, in particular the highest priority job, is assigned the required resources. The or each further redundant job is herewith preferably deleted from the respective queue with the allocation of resources to the highest priority job. In an expedient embodiment, the redundant jobs are linked to the highest priority corresponding job such that any acknowledgement information, which is fed back to, the job initiator after implementing the job, is also generated for the job initiator of the or each further redundant job after processing the first corresponding job. The term “job initiator” herewith refers to the system component, in particular a software application, which has generated the respective job. An automatic job is herewith generally a software application which runs without user interaction. By contrast, an interactive job is herewith a software application, with the aid of which the respective user has generated the job, for instance a program for displaying and processing medical image data.

However, the deletion of the redundant jobs expediently only then takes place if a “perfect” hash code is used, i.e. a hash code which clearly identifies the associated job. Such a hash code occasionally has a comparatively large memory space requirement, particularly if a large number of different job types are to be encoded. In a variant of the inventive method, instead of a perfect hash code, a “non-perfect hash code” is used, which generally requires less memory space, whereby different types of jobs are however assigned the same hash code with a certain, albeit minimal probability. In this case, all that happens is that jobs with the same hash code are executed at the same time. After processing the first job of such a group of jobs with the same hash code, a check is then carried out to determine whether the or each further job in the group has become superfluous by executing the first job. If this check is positive, this job is deleted. Otherwise, this job is processed according to its position in the queue.

To prevent the data processing facility performing the image processing from “running down” despite an inventive resource allocation, in other words the available resources being allocated by the processing of the preprocessing jobs such that the overall performance of the data processing facility is restricted, in a preferred method variant, an additional monitoring process is provided, within the scope of which the resource utilization is monitored in particular continuously. The resource allocation is herewith temporarily halted or delayed, if the defined resource utilization exceeds a predetermined limit value.

This limit value can be uniformly predetermined for all job types. A lower limit value for automatic jobs is however preferably predetermined than for interactive jobs. With increasing resource utilization, the resource allocation is thus initially halted for the automatic jobs, while the interactive jobs are initially still processed without restriction. The processing of the interactive jobs is also temporarily halted or delayed only if the resource utilization increases further, despite these measures, so that the overall performance of the data facility implementing the image processing is always guaranteed.

The inventive system of at least one embodiment is generally set up to implement the afore-described method in one of its variants or a combination of these variants using programming- or circuit-based technology. The inventive system of at least one embodiment includes at least,
a classification module (abbreviated below to classifier), which is set up to classify a plurality of jobs in order to determine whether they were generated interactively by user request or automatically,
an execution coordination module (also abbreviated below to execution coordinator), which is set up to place each job in a queue in accordance with the classification and to request data processing resources for this job, and
a resource allocation module (abbreviated below to resource allocator), which is set up to allocate resources for job implementation to each job in consideration of the classification, and herewith to allow for interactive jobs with a higher priority than automatic jobs.

The classifier is preferably set up so as to assign the interactive jobs and the automatic jobs to one of at least two, preferably one of at least three load classes, in accordance with the resource requirement to be expected in each instance.

Within the system a queue is preferably provided for each load class, which is specifically assigned to this load class.

In at least one embodiment of the system, the resource allocator is set up only to allocate resources to automatic jobs if there are no interactive jobs in the assigned queue and/or in one of the assigned queues.

In a further variant of the system, the resource allocator is set up to allocate resources to jobs in different load classes in accordance with a predetermined distribution key which is described in more detail above in conjunction with the method.

In a further variant of at least one embodiment of the invention, the system is in turn preferably set up to generate a label identifier, in particular in the form of a hash code, for each job, said label identifier identifying the type of preprocessing and the data to be preprocessed. In this system embodiment, the execution coordinator is also preferably set up only once to request the required resources for several jobs placed in the queue and/or queues, if these jobs correspond in terms of the respectively assigned label identifier.

In a further variant of the system, the resource allocator is in turn finally set up to additionally monitor the resource utilization and to temporarily halt or delay the resource allocation if the resource utilization exceeds a predetermined limit value.

The word “system” here relates in the narrower sense to a software product, said software product automatically implementing the afore-described method if it runs on a suitable data processing system. The modules introduced above in connection with the system are software modules of this software product, with this software module optionally forming software modules which are implemented independently of one another, or being able to be implemented wholly or partially as functional components of a uniform software product.

In a broader sense, a data processing facility, in particular in the form of a client server structure, is understood as a system in which client server structure a software product automatically implementing the afore-described method is implemented.

At least one embodiment of the inventive system is implemented in particular within the scope of a so-called PACS (Picture Archiving and Communication System).

The afore-described apparatus and system variants can, as far as possible, be combined arbitrarily with one another. In particular, the aforecited embodiments relating to the individual method variants can be transferred to the functional embodiment of the corresponding system components in each instance.

### BRIEF DESCRIPTION OF THE DRAWINGS

An example embodiment of the invention is subsequently described in more detail with the aid of a drawing, in which

FIG. 1 shows a schematic block diagram of a PACS (Picture Archiving and Communication System) connected to a number of imaging modalities using a data link, the PACS having a number of clients and an image processing server, in which a system for resource allocation is implemented for the electronic preprocessing of digital medical image data, and

FIG. 2 shows a schematic sequence diagram of the interaction of components of the system with one another and with a client generating a preprocessing job.

Parts, variables and structures which correspond to one another are always provided with the same reference Characters in all figures.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

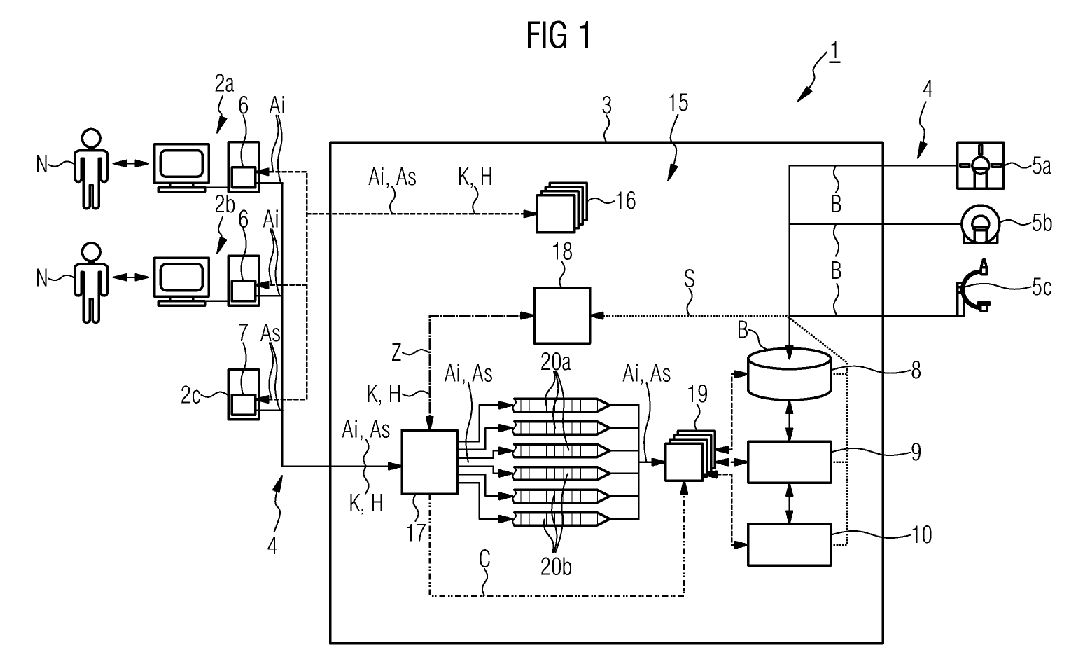

FIG. 1 shows a very simplified representation of a so-called Picture Archiving Communication System (abbreviated below as PACS1), i.e. a data processing network for archiving and transferring digital image data in the medical field.

The PACS 1 includes a number of working computers designated below as clients 2a, 2b and 2c and an (image processing) server 3. The clients 2a-2c are connected using a data link by way of a data transmission network 4 only suggested in the Figure, in particular a LAN. On the other hand, the server 3 is connected using a data link to a number of imaging modalities 5a, 5b and 5c via the data transmission network 4.

The clients 2a and 2b are for instance so-called diagnostic station. Each of the clients 2a and 2b is formed for example by a personal computer with a connected screen in each instance. A diagnostic application 6 is implemented on each of the clients 2a and 2b using software.

The client 2c is actually a server, namely a so-called DICOM server, on which a DICOM receiver 7 compliant with the DICOM (Digital Imaging and Communications in Medicine) standard is implemented using software.

The modalities 5a-5c connected to the PACS 1 are, by way of example only, a magnetic resonance (MR) tomograph and/or a computed tomograph (CT) and/or an x-ray C-arm device.

During operation of the facility shown in FIG. 1, the medical image data B is generated by means of the modalities 5a-5c and stored in an image memory 8 by way of the DICOM server (i.e. of the client 2a). By way of example, the image memory 8 is assigned to the server 3 in FIG. 1. It could likewise also be provided however as a component of the DICOM server (i.e. of the client 2c) or as a separate network component. In particular, the image memory 8 may also be formed from several units distributed over several network components.

The image data B can be called up by the image memory 8 to the clients 2a-2c. In particular, the image data B can be displayed on the clients 2a and 2b by way of the diagnostic application 6 in interaction with the user N of the respective client 2a and/or 2b and processed.

Further image processing processes are also triggered by the DICOM receiver 7 implemented in the client 2c independently of a user interaction.

For instance, for each medical image data set assigned to the angiography (vessel representation), said image data set having been received by one of the modalities 5a-5c, the DICOM receiver 7 automatically prompts a bone removal process, with which the image of the bones is removed from the data set using image processing technology, in order to render the vessels more easily recognizable. The DICOM receiver 7 herewith prompts this process using uniform standard parameters, which, in most cases, provide a useable, but not always optimum result. The user N of the client 2a, which subsequently diagnoses a thus modified image data set, can, particularly if he regards the result of the automatic bone removal individually as being improvable, interactively prompt the bone removal process with changed parameters using the diagnostic application 6.

The image processing processes are conventionally implemented at least mostly non-locally by the clients 2a-2c, but instead by the image processing server 3 provided herefor. To this end, the server 3 includes a main memory 9 and a processor 10, subsequently also referred to as CPU. Notwithstanding the representation, a server farm with several cooperating servers 3 can also be provided instead of an individual server 3. In addition or alternatively, the or each server 3 can also include several working memories 9 and/or processors 10.

The image memory 8, the main memory 9 and the processor 10 essentially form the (data processing) resources needed to process the medical image data B. The resource requirement needed to execute an image processing process is herewith determined in particular by the necessary requirement of main memory 9.

To prompt an image processing process, the respective client 2a or 2b generates a (preprocessing) job Ai in interaction with the respective user N, said (preprocessing) job specifying the type of image processing process to be executed, in particular the algorithm to be used and the image data set to be processed, and routes this to the server 3. Similarly, the client 2c also generates a (preprocessing) job As, which is routed to the server 3 in order to prompt each image processing process. Irrespective of the user interaction, the jobs Ai and As are similar, so that from the perspective of server 3, the DICOM server acts like an additional “client”, provided the action of the DICOM server essentially equates to the action of an additional user.

Since with jobs Ai, contrary to jobs A2, a user N always waits for the completion and thus the jobs A1 are regularly subject to a higher level of urgency than the jobs A2, the server 3 makes a distinction in accordance with the invention between the “interactive” jobs Ai and the “automatic” jobs As, and treats the first with higher priority.

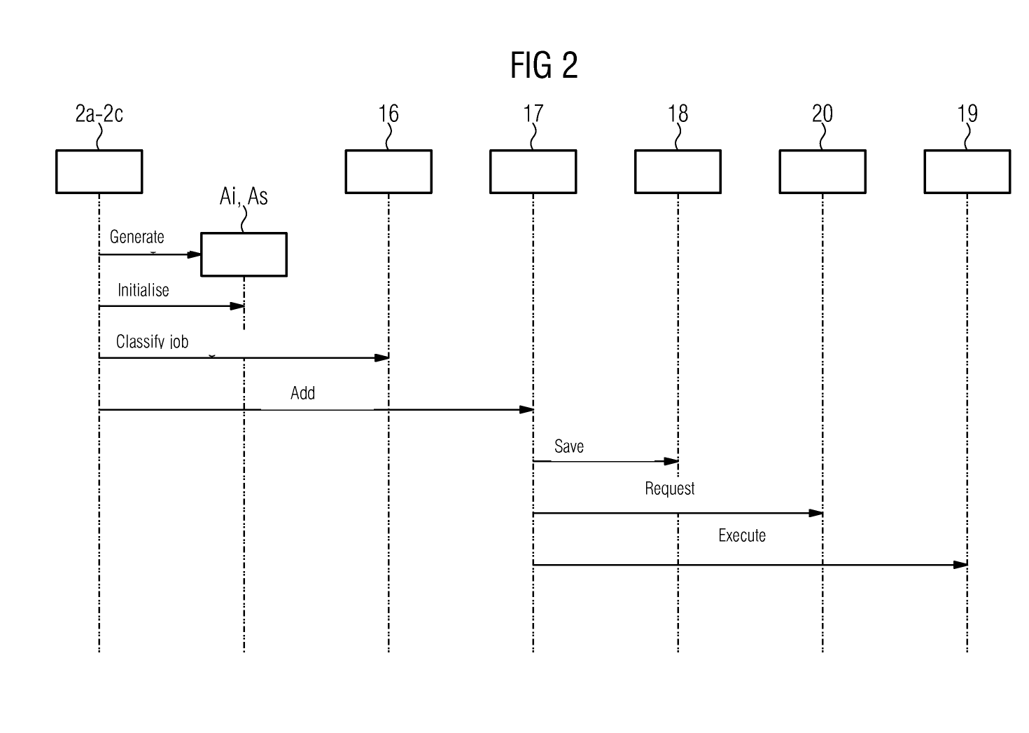

To allocate the available resources to the jobs Ai and As generated by the clients 2a-2c, a software application subsequently referred to as system 15 is implemented in the server 3. The system 15 herewith includes, in the form of a software module in each instance, a number of classifiers 16, an execution coordinator 17, a resource allocator 18, and a number of job initiators 19. The system 15 also includes three queues 20a and 20b embodied in each instance in the form of logical first-in-first-out memories. All aforecited software modules are implemented in the server 3 in the example shown. Irrespective of this, the classifiers 16 can however also be implemented locally in the clients 2a-2c. The interaction of these modules with one another and with the clients 2a-2c is shown schematically in FIG. 2.

Each of the jobs Ai or As is initially fed to one of the classifiers 16 after initialization by the corresponding client 2a-2c. Each of the classifiers 16 is herewith assigned to a specific job type, i.e. a specific image processing process and exclusively obtains jobs Ai and/or As of this job type. An interactive or automatic job Ai and/or As, whose purpose is to calculate a 3D image data set, is therefore routed to a classifier 16 assigned to this image processing process. A job Ai or As for a bone removal process is routed accordingly to another classifier 16.

By way of the respective classifier 16, each routed job Ai and/or As is assigned to one of the load classes listed below in accordance with its type of generation (interactively or automatically) and in accordance with the resource requirement to be expected for the processing of this job A1 or As.

“interactively small”

“interactively medium”

“interactively large”

“automatically small”

“automatically medium”

“automatically large”

Each classifier 16 determines the resource requirement to be expected by referring back to stored decision rules on the basis of the job type and based on the size of the image data set to be processed. In an example embodiment, the classifier 16 exclusively draws on the main memory requirement to be expected as a measure of the resource requirement. The classifiers 16 herewith classify a given job Ai and/or As.
as “interactively small” or “automatically small”, if the main memory requirement to be expected does not reach a first limit value of for instance 100 MB,
as “interactively medium” or “automatically medium”, if the main memory requirement to be expected lies between the first limit value and a second limit value of for instance 500 MB, and
as “interactively large” or “automatically large”, if the main memory requirement to be expected also exceeds the second limit value.

As a result of the classification, the respective classifier 16 assigns a classification label K identifying the load class to the job Ai or As as an attribute.

The classifier 16 also calculates a hash code H from the details of the job Ai or As, which relate to the job type and the image data set to be processed, the hash code clearly identifying the job type of the job Ai or As and assigning this hash code H to the job Ai, A2 as a further attribute.

The respective classifier 16 returns the classification label K and the hash code H to the job-initiating client 2a-2c, which then passes these attributes together with the job A1 and/or As to the execution coordinator 17.

In accordance with the classification label K, the execution coordinator 17 places each interactive job Ai in one of the three queues 20a, and each automatic job As in one of the three remaining queues 20b. Each of the queues 20a and 20b is herewith assigned to a specific load class and exclusively obtains jobs Ai or As of this load class. The queue 20a assigned to the load class “interactively medium” thus exclusively obtains interactive jobs A1 with a medium resource requirement.

After placing each job Ai, As into the respectively assigned queue 20a, 20b, the execution coordinator 17 also requests the necessary resources for processing this job A1, As from the resource allocator 18, by transferring the classification label K and the hash code H of the job Ai, As to the resource allocator 18.

In accordance with the classification label K, the resource allocator 18 assigns a set of logical resources to each job Ai, As, said logical resources corresponding to the average resource requirement of jobs Ai, As of the associated load class, and informing the execution coordinator 17, if the respective job Ai, As in the assigned queue 20a, 2b is returned to the first position, at a given time by transferring an allocation message Z, such that the resources needed to process the job Ai, As are available.

Upon receipt of the allocation message Z, the execution coordinator 17 starts one of the job initiators 19 by outputting a start command C, said job initiator 19 then implementing the specified image processing process on the image data set specified according to the job in accordance with the job Ai and/or As to be executed by actuating the image memory 8, the main memory 9 and the processor 10. Each type of job is herewith assigned an associated job initiator 19. In particular, an associated job initiator 19 therefore also exists for each classifier 16. The latter is however concealed from the clients 2a-2c. Instead the clients 2a-2c only communicate directly with the associated classifier 16.

With the resource allocation, the resource allocator 18 prioritizes the queues 20a, which are assigned to the interactive jobs Ai and thus to the load classes “interactively small”, “interactively medium” and “interactively large”. Resources are then only allocated by the resource allocator 18 to the automatic jobs As in the queues 20b if no interactive jobs Ai exist in the queues 20a. Within the queue 20a, the resource allocator 18 allocates the required resources to the respective jobs Ai in accordance with a stored distribution key, which defines a number of jobs A1 of this load class as a function of the state of the queue 20a for each load class, it being possible to process said number of jobs consecutively a maximum number of times. A corresponding distribution key is shown by way of example below in TAB 1.

TABLE 1
Distribution key for the allocation of interactive jobs Ai

| | small | medium | large |
|---|---|---|---|
| 000 | — | — | — |
| 001 | — | — | 2 |
| 010 | — | 4 | — |
| 011 | — | 2 | 1 |
| 100 | 8 | — | — |
| 101 | 4 | — | 1 |
| 110 | 6 | 3 | — |
| 111 | 3 | 2 | 1 |

The three digit binary numbers in the left column of the table reproduce the state of the queues 20a assigned to the load classes “interactively small”, “interactively medium” and “interactively large”. The value “1” herewith indicates that jobs Ai are placed in the corresponding queue 20a, while the value “0” indicates that the respective queue 20a is empty. The binary number “001” means for instance that only jobs Ai of the load class “interactively large” are present, while the two other queues 20a are empty. The number “110” means accordingly that jobs Ai of the load classes “interactively small” and “interactively medium”, but no jobs Ai of the load class “interactively large” exist in the queues 20a.

The numbers in the columns of TAB 1 headed “small”, “medium” and “large” specify how often jobs Ai of the respective load class are assigned to a maximum number of consecutive resources before the allocation for a job in another category Ai takes place. For instance, it follows from the last line of TAB 1 that in the presence of jobs Ai in all queues 20a (“111”), a maximum of three small jobs Ai are processed consecutively until resources are allocated to a medium or large job Ai by means of the resource allocator 18.

The resource allocator 18 also accesses a corresponding distribution key, nevertheless with deviating characteristics, for the resource allocation to the automatic jobs As.

Subordinate to the afore-described decision rules, the resource allocator 18 prioritizes the jobs Ai or As in accordance with the setting time in the respective queue 20a or 2b, with earlier placed jobs Ai or As being preferred. While this is possible in accordance with the respective allocation key, the resource allocator 18 therefore always allocates the corresponding resources to the oldest interactive job A1 or, in the absence of such, to the oldest automatic job As.

To prevent redundant processing of jobs As, Ai, which equate to one another in respect of the processing process and the data to be processed, the execution coordinator 17 compares the hash codes H of the jobs Ai, As placed in the queues 20a and 20b. If two or more jobs Ai and A2 are found here with an identical hash code H, the execution coordinator 17 allows for the allocation of resources only for the highest priority of these jobs Ai, As. The or each further redundant job Ai, As is deleted from the respective queue 20a, 20b by the execution coordinator 17, as soon as the allocation to the highest-priority job Ai, As takes place.

To rule out overloading of the resources despite a controlled resource allocation, the resource allocator 18 also continuously monitors the utilization state of the image memory 8 in respect of its read and write performance, the utilization degree of the main memory 9 and the current load of the processor 10 (CPU load). The resource allocator 18 herewith compares corresponding status data S with associated stored threshold values.

A separate threshold value set is herewith stored in each instance for the processing of automatic jobs As on the one hand and the processing of interactive jobs A1 on the other hand, with the threshold values applying to the processing of automatic jobs As always being lowered relative to the threshold values which apply to the interactive jobs Ai. For instance, as threshold values for the processing of automatic jobs As

a maximum main memory utilization of 70%,

a maximum CPU load of 75% and

a maximum read/write utilization of the image memory 8 of 65%

are defined, while as threshold values for the processing of interactive jobs Ai

a maximum main memory utilization of 85%,

a maximum CPU load of 93% and

a maximum read/write utilization of the image memory 8 of 85% are stored.

If the resource allocator 18 determines the exceeding of at least one of the threshold values by the respective state variable A, said resource allocator 18 herewith halts the allocation of resources to jobs Ai and/or As of the corresponding category for a predetermined period of time.

On account of the threshold values lowered for automatic jobs As, the processing of automatic jobs As is herewith initially halted with an increasing resource utilization. It is only when the resource utilization increases further, despite this measure, that the resource allocator 18 also halts the allocation of resources to interactive jobs Ai.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, non-transitory computer readable medium and non-transitory computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a non-transitory computer readable medium and is adapted to perform any one of the aforementioned methods when run on a computer device (a device including a processor). Thus, the non-transitory storage medium or non-transitory computer readable medium, is adapted to store information and is adapted to interact with a data processing facility or computer device to execute the program of any of the above mentioned embodiments and/or to perform the method of any of the above mentioned embodiments.

The non-transitory computer readable medium or non-transitory storage medium may be a built-in medium installed inside a computer device main body or a removable non-transitory medium arranged so that it can be separated from the computer device main body. Examples of the built-in non-transitory medium include, but are not limited to, rewriteable non-volatile memories, such as ROMs and flash memories, and hard disks. Examples of the removable non-transitory medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

### LIST OF REFERENCE CHARACTERS

1 PACS
2a-2c Client
3 (Image processing) server
4 Data transmission network
5a-5c Modularity
6 Diagnostic application
7 DICOM receiver
8 Image memory
9 Main memory
10 Processor
15 System
16 Classifier
17 Execution coordinator
18 Resource allocator
19 Job initiator
20a,20b Queue
Ai (Preprocessing) job
As (Preprocessing) job
B Image data
C Start command
H Hash code
K Classification label
N User
S State variable
Z Allocation message

What is claimed is:

1. A method for resource allocation for the electronic preprocessing of digital medical image data, comprising:
classifying each of a plurality of preprocessing jobs to determine whether they were generated by interactive user request or automatically;
placing each preprocessing job in a queue in accordance with the classification; and
assigning data processing resources for job execution to each preprocessing job in consideration of the classification, with interactive preprocessing jobs being taken into consideration with a relatively higher priority than automatic preprocessing jobs.

2. The method as claimed in claim 1, wherein the interactive preprocessing jobs and the automatic preprocessing jobs are also assigned to one of at least two load classes in accordance with the resource requirement to be expected.

3. The method as claimed in claim 1, wherein the preprocessing jobs are placed in class-specific queues.

4. The method as claimed in claim 3, wherein data processing resources are then only assigned to automatic preprocessing jobs if no interactive preprocessing jobs are present in at least one of the assigned queue and one of the assigned queues.

5. The method as claimed in claim 2, wherein data processing resources are assigned to preprocessing jobs of a different load class in accordance with a distribution key.

6. The method as claimed in claim 5, wherein a maximum number of preprocessing jobs of this load class, which are to be executed consecutively, is defined by the distribution key for each load class.

7. The method as claimed in claim 1, wherein a label identifier, in particular in the form of a hash code, is generated for each preprocessing job, said label identifier identifying a type of preprocessing and a data to be preprocessed and wherein data processing resources are only allocated once to several preprocessing jobs placed in at least one of the queue and the queues with corresponding label identifiers.

8. The method as claimed in claim 1, wherein the resource utilization is monitored and wherein the resource allocation is temporarily halted or delayed if the resource, utilization exceeds a limit value.

9. A system for resource allocation for an electronic preprocessing of digital medical image data, comprising:
at least one classification module, set up to classify a plurality of preprocessing jobs in order to determine whether each of the plurality of preprocessing jobs were generated interactively by user request or automatically;
an execution coordination module, set up to place each preprocessing job in a queue in accordance with the classification and to request data processing resources for each preprocessing job; and
a resource allocation module, set up to allocate data processing resources for job execution to each preprocessing job taking account of the classification and herewith to allow for interactive preprocessing jobs with a relatively higher priority than automatic preprocessing jobs.

10. The system as claimed in claim 9, wherein the at least one classification module is also set up to allocate the interactive preprocessing jobs and the automatic preprocessing jobs to one of at least two load classes in accordance with the resource requirement to be expected.

11. The system as claimed in claim 9, wherein one of the specifically assigned queues, for halting preprocessing jobs of a respective load class of the at least two load classes, is provided for each of the at least one load class.

12. The system as claimed in claim 11, wherein the resource allocation module is set up to allocate data processing resources to automatic preprocessing jobs if no interactive preprocessing jobs exist in at least one of the assigned queue and one of the assigned queues.

13. The system as claimed in claim 10, wherein the resource allocation module is set up to allocate data processing resources to preprocessing jobs of a different load class in accordance with a distribution key.

14. The system as claimed in claim 9, wherein the at least one classification module is set up to generate a label identifier for each preprocessing job, said label identifier identifying the type of preprocessing and the data to be preprocessed, and wherein the execution coordination module is set up to request the data processing resources once only for several preprocessing jobs with an identical label identifier placed in at least one of the queue and the queues.

15. The system as claimed in claim 9, wherein the resource allocation module is set up to also monitor the resource utilization and to temporarily halt or delay the resource allocation if the resource utilization exceeds a limit value.

16. The method as claimed in claim 2, wherein the interactive preprocessing jobs and the automatic preprocessing jobs are also assigned to one of at least three load classes in accordance with the resource requirement to be expected.

17. The method as claimed in claim 7, wherein the label identifier is in the form of a hash code.

18. The system as claimed in claim 10, wherein the interactive preprocessing jobs and the automatic preprocessing jobs are also assigned to one of at least three load classes in accordance with the resource requirement to be expected.

19. The system as claimed in claim 14, wherein the label identifier is in the form of a hash code.
